(19) United States
(12) Patent Application Publication
(10) Pub. No.: US 2012/0116848 A1
(43) Pub. Date: May 10, 2012

(54) OPTIMIZING BUSINESS OPERATIONAL ENVIRONMENTS

(75) Inventors: Thomas GARGIULO, Manalapan, NJ (US); Richard M. HAAS, Wellesley, MA (US); Randy S. JOHNSON, O Fallon, MO (US); Tedrick N. NORTHWAY, Wood River, IL (US); H. William RINCKEL, Prospect, CT (US)

(73) Assignee: INTERNATIONAL BUSINESS MACHINES CORPORATION, Armonk, NY (US)

(21) Appl. No.: 12/943,645

(22) Filed: Nov. 10, 2010

(51) Int. Cl. G06Q 10/00

(52) U.S. Cl. 705/7.36

(57) ABSTRACT

Methods and systems are provided to optimize business value by providing and/or implementing business solutions, e.g., solutions to improve operational environments. A method is implemented in a computer infrastructure which has computer executable code tangibly embodied on a computer readable storage medium having programming instructions operable to: provide an initial assessment of business operations, using a framework based on lean capabilities and lean components, as well as at least one of business and environmental constraints; determine a need for improvement based on scores provided in the initial assessment; and provide a complete assessment using business drivers and specifications of a solution to identify areas for improvement of business operations.

### TECHNICAL FIELD

The present invention generally relates to optimizing business value and more particularly, to methods and systems to optimize business value by providing and/or implementing solutions to improve operational environments.

### BACKGROUND

Service providers and consultants provide strategies and solutions to business in order to increase efficiency and profitability of the business. For example, some solutions may involve upgrading information technology infrastructure, while other solutions may be related to more efficient allocation of work to qualified personnel. These strategies and solutions also focus on providing customers with improved customer service.

Historically, service providers and consultants have focused on physical environments (i.e., number of servers, storage space, etc) as the primary means to fashion business solutions. However, service providers and consultants fail to adequately perform accurate pre-contract diagnostics of the maturity of clients' operational environments. By focusing on physical counts and financial information, service providers and consultants have often overlooked operational aspects that drive an understanding of how work is actually performed in an environment. For this reason, it is very difficult, if not impossible, to consistently address issues in the operational environment, and provide compelling contract deliverables in a timely and cost efficient manner. In fact, even when there are existing assessments prior to engagement of services, these assessments are often not performed consistently and fail to tie the providers' capabilities to their delivery best practices.

In effect, this results in downstream performance issues and inability to maximize benefits in the course of rendering contacted services to a client. Issues experienced can include, for example, poor systems performance, technical features that fail to address key issues, customer service expectations/customer satisfaction not being met, etc., and in general, failure to perform and deliver promised services.

### SUMMARY

In a first aspect of the invention, a method implemented in a computer infrastructure has computer executable code tangibly embodied on a computer readable storage medium having programming instructions. The program instructions are operable to: provide an initial assessment of business operations, using a framework based on lean capabilities and lean components, as well as at least one of business and environmental constraints; determine a need for improvement based on scores provided in the initial assessment; and provide a complete assessment using business drivers and specifications of a solution to identify areas for improvement of business operations.

In another aspect of the invention, a system comprises a system implemented in hardware. The system comprises an assessment tool operable to provide: an initial assessment of lean components and business constraints of a business; and a complete assessment of drivers of value which are correlated to technical specifications and provided in response to the initial assessment. The system further comprises a report tool to generate a report of at least the complete assessment.

In an additional aspect of the invention, a computer program product comprises a computer usable storage medium having readable program code embodied in the storage medium. The computer program product comprises at least one component operable to: correlate assessments to lean components associated with a business; correlate a business environment to business constraints; return areas of improvement opportunity based on the correlated assessments and business environment; correlate assessment results to appropriate value drivers for the business; provide an automated identification of specifications of a solution based on results of the value drivers; and return areas of prioritized technical specifications of opportunity based on the automated identification.

In a further aspect of the invention, a computer system for assessing business opportunities comprises a CPU, a computer readable memory and a computer readable storage media. First program instructions correlate assessments to lean components associated with a business. Second program instructions correlate a business environment to business and environment constraints. Third program instructions correlate assessments to appropriate value drivers for the business. Fourth program instructions correlate assessments to specifications of a solution and provide automated identification of specifications of a solution that can drive benefit based on results of the value drivers. The first, second, third and fourth program instructions are stored on the computer readable storage media for execution by the CPU via the computer readable memory.

In yet another aspect of the present invention, a method of deploying a system for assessing business opportunities comprises providing a computer infrastructure, being operable to: provide an initial assessment of business operations using business constraints and lean capabilities including lean components; determine a need for improvement based on scores provided in the initial assessment; and provide a complete assessment using business drivers and specifications of a solution based on the need for improvement.

### BRIEF DESCRIPTION OF THE SEVERAL VIEWS OF THE DRAWINGS

The present invention is described in the detailed description which follows, in reference to the noted plurality of drawings by way of non-limiting examples of exemplary embodiments of the present invention.

FIG. 1 is an illustrative environment for implementing the steps in accordance with aspects of the invention;

FIG. 2 shows an exemplary component level architecture in accordance with aspects of the present invention;

FIG. 3 shows a table of lean components with related questions, answers and scores in accordance with aspects of the present invention;

FIG. 4 shows a table of constraint categories with related questions, answers and scores in accordance with aspects of the present invention;

FIGS. 5a-5c show graphical representations of business improvements identified using an assessment tool in accordance with aspects of the present invention;

FIG. 6 shows a swim lane diagram of an initial assessment stage in accordance with aspects of the present invention;

FIG. 7 shows a swim lane diagram of a complete client operational assessment stage in accordance with aspects of the present invention;

FIG. 8 shows a flow diagram of processing steps implemented by the assessment tool during a complete client operational assessment stage in accordance with aspects of the present invention;

FIG. 9 shows a venn diagram of drivers of value and technical specifications (opportunity levers) obtained by the assessment tool in accordance with aspects of the present invention; and

FIGS. 10a-10d show mapping scenarios in accordance with aspects of the present invention.

### DETAILED DESCRIPTION

The present invention generally relates to optimizing business value and more particularly, to methods and systems to optimize business value by providing and/or implementing solutions to improve operational environments. The methods and systems of the present invention provide an assessment tool for analyzing potential costs and benefits of at least one change to a target business capability based on high-level specifications of a solution. Advantageously, the methods and systems of the present invention enable early insight into a client's process maturity and operational environment so that they can be mapped to delivery capabilities of a service provider, e.g., consultant, etc., at early in an engagement. For example, the methods and systems of the present invention can identify salient features of a business environment so that technical solutions can be created that drive value for the business, at an early stage. In illustrative embodiments, the assessment can use a structured questionnaire that targets symptom-level effects and prototypical answers attempting to identify basic, high-level root causes.

In more specific embodiments, the methods and systems of the present invention provide a tool to assess, for example, the maturity of an information technology (IT) and/or business environment by utilizing high-level specifications of a solution (also referred to herein as opportunity levers) linked to business values to clearly identify focus areas to improve within the IT and/or management (business) environment. For example, the initial assessment provides process maturity questions mapped to Lean components within a Lean framework, with the questions being weighted on productivity and quality, for example. In embodiments, the present invention can assess relevant business and environmental constraints, and further segment the constraints into distinct constraint components. The present invention can use a framework based on value drivers and high-level characteristics of a solution that can be adjusted to deliver different levels of value, further performing an evaluation of the environment by clearly linking specifications of a solution with value drivers.

Even more specifically, the methods and systems of the present invention provide a disciplined, consistent methodology to assess the maturity of an IT and/or management (business) environment, utilizing high-level technical specifications that are linked to the business value driven by those technical specifications. This allows the service provider (e.g., consultant) to clearly identify the focus areas that need improvement. This, in turn, provides the necessary information to the service provider so that they can identify and provide early stage solutions during a proposal process and, more granular solutions after providing a complete business assessment.

In implementation, the methods and systems can be performed in two stages: initial assessment stage and complete client operational assessment stage. In the initial assessment stage, the service provider (e.g., consultant) performs an initial, high-level evaluation of process maturity and business/environmental constraints. The initial assessment is used to determine the areas of high impact where capabilities can drive value for the client, helping to develop initial client and solution strategies that better address the client's business issues. The complete client operational assessment, on the other hand, utilizes a framework based on value drivers and high-level specifications of a solution that can be adjusted to deliver different levels of value. For example, the complete client operational assessment performs an evaluation of the opportunity which clearly links a technical specification with the impact it has on the customer value through the driver of the value. This enables the service provider (e.g., consultant) to clearly and consistently articulate the connection between different specifications of a solution and their business impact. Also, the complete client operational assessment provides a view of the potential risk of a client on transition and transformation of business processes.

### System Environment

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

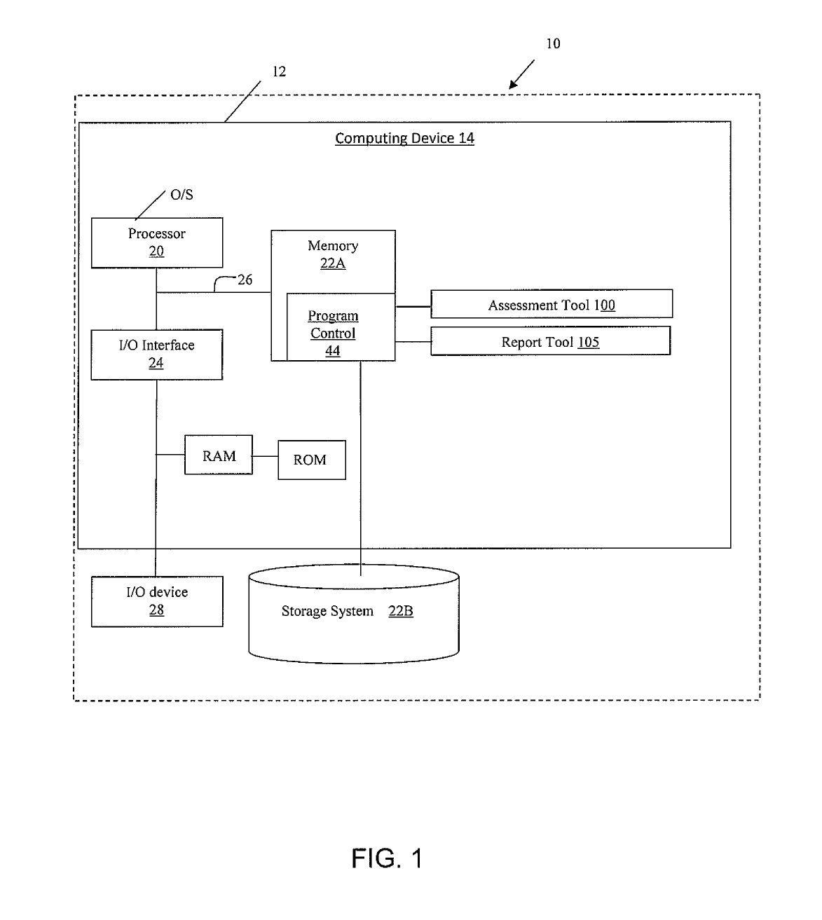

FIG. 1 shows an illustrative environment 10 for managing the processes in accordance with the invention. To this extent, the environment 10 includes a server or other computing system 12 that can perform the processes described herein. In particular, the server 12 includes a computing device 14. The computing device 14 can be resident on a network infrastructure or computing device of a third party service provider (any of which is generally represented in FIG. 1).

The computing device 14 also includes a processor 20, memory 22A, an I/O interface 24, and a bus 26. The memory 22A can include local memory employed during actual execution of program code, bulk storage, and cache memories which provide temporary storage of at least some program code in order to reduce the number of times code must be retrieved from bulk storage during execution. In addition, the computing device includes random access memory (RAM), a read-only memory (ROM), and an operating system (O/S).

The computing device 14 is in communication with the external I/O device/resource 28 and the storage system 22B. For example, the I/O device 28 can comprise any device that enables an individual to interact with the computing device 14 (e.g., user interface) or any device that enables the computing device 14 to communicate with one or more other computing devices using any type of communications link. The external I/O device/resource 28 may be for example, a handheld device, PDA, handset, keyboard etc.

In general, the processor 20 executes computer program code (e.g., program control 44), which can be stored in the memory 22A and/or storage system 22B. Moreover, in accordance with aspects of the invention, the program control 44 controls an assessment tool 100 and a report tool 105 to perform the processes described herein. The assessment tool 100 and the report tool 105 can be implemented as one or more program code in the program control 44 stored in memory 22A as separate or combined modules. Additionally, the assessment tool 100 and the report tool 105 may be implemented as separate dedicated processors or a single or several processors to provide the function of these tools. While executing the computer program code, the processor 20 can read and/or write data to/from memory 22A, storage system 22B, and/or I/O interface 24. The program code executes the processes of the invention. The bus 26 provides a communications link between each of the components in the computing device 14.

In embodiments, the assessment tool 100 can identify and provide solutions for different business operations using an initial assessment and, thereafter, complete client operational assessment of business operations such as, for example, management systems, working structures, training, defect prevention systems, controls, IT infrastructure, etc. In embodiments, the initial assessment is designed to provide a high-level understanding of the client opportunity and direct the strategy generation using targeted questions aligned to specific Lean components and business and environment constraints (which may be scored during client interviews); whereas, the complete client operational assessment provides a finer or more granular understanding of the client opportunity and strategic solutions to drive business solutions, e.g., improve infrastructure, business drivers, etc.

In embodiments, the initial assessment may include a set of questions to evaluate Lean capabilities such as, for example, operating systems, management systems and behavioral components. The Lean capabilities can be divided into exemplary Lean components such as that shown in TABLE 1 below, in order to provide initial recommendations (e.g., solutions) to improve business operations. These initial recommendations can be used as drivers for further strategic evaluation of the business.

TABLE 1

| LEAN CAPABILITY | LEAN COMPONENT |
|---|---|
| OPERATING | ADVANCED POOLING, e.g., how the |
| SYSTEM | business groups similar work in similar |
| | geographic regions, using workers with the |
| | same or similar skill sets. |
| | BANDING, e.g., how the business matches the |
| | type of work with workers that have the |
| | appropriate skill set. |
| | DISPATCHING, e.g., the process of |
| | monitoring all sources of incoming work for a |
| | pool and managing the assignment, progress, |
| | and completion of that work. |
| | FLEXIBLE WORK STRUCTURES, e.g., how |
| | the business provides flexibility to workers or |
| | infrastructure so to be as efficient as possible. |
| | PROCESS MATURITY, e.g., the level of |
| | sophistication of the business processes. |
| | STANDARDIZATION, e.g., to what extent |
| | are their standardized policies and procedures |
| | to make the business most efficient. |
| | DEFECT PREVENTION, e.g., how the |
| | business proactively deals with defect |
| | preventions based on, for example, isolated |
| | incidents for a same service and/or product. |
| MANAGEMENT | METRICS, e.g., how the business provides |
| SYSTEM | objective criteria for managing workers. |
| | PERFORMANCE MANAGEMENT, e.g., how |
| | the business evaluates improvements in |
| | management performance issues. |
| | SPAN OF CONTROL, e.g., how the |
| | management controls the business processes |
| | such as, for example, infrastructure, ratio of |
| | managers to workers, etc. |
| MINDSETS, | CROSS TRAINING, e.g., does the business |
| BEHAVIORS & | have adequate training programs to improve its |
| CAPABILITIES | workforce and/or to ensure that there are |
| | adequate back-ups for workers that are absent |
| | due to, for example, illness or extended leave, |
| | etc. |
| | CONTINUAL IMPROVEMENT, e.g., is there |
| | any improvement in business practices over a |
| | certain time period, etc. |
| | PROBLEM-SOLVING, e.g., does the business |
| | have any mechanisms to identify and then |
| | solve problems. |
| | ROLE-MODELING, e.g., does the business |
| | understand all of the roles of its workers and |
| | how they are most efficiently used, etc. |

It should be understood by those of ordinary skill in the art that other components and capabilities are also contemplated by the present invention, and that the above illustrative examples should not be considered limiting factors of the invention. The exemplary Lean components can be assessed by maturity level that is processed by the assessment tool 100 during the initial assessment stage. The maturity level may be obtained, for example, by a score assigned to answers related to particular questions. Based on, for example, an average of the score (or a weighted average of the score), an initial assessment may be obtained, which is indicative of the maturity level for each of the Lean components. The initial assessment may by a high-level solution, provided by the report tool 105, taking into account, for example, the business and environment constraints.

The business and environment constraints can be divided into different categories such as, for example, flexible constraints and inflexible constraints. The flexible constraints may include, for example, restrictions or limitations that may be changed by the business; whereas, the inflexible constraints may include restrictions that are outside of the control of the business such as, for example, regulatory and legal constraints. These constraints can be segmented into distinct constraint components. Identification of these constraints enables client teams to engage in dialogue with the client as to potential trade-offs between constraints and their ability to deliver higher levels of value, e.g., improved business solutions.

TABLE 2, below, shows constraint types, e.g., flexible and inflexible, and exemplary constraint components. The constraint types and constraint components, much like the Lean components noted above, are merely illustrative examples and should not be considered a limiting feature of the present invention.

TABLE 2

| CONSTRAINT TYPE | CONSTRAINT COMPONENT |
|---|---|
| Flexible Constraints | Dedicated resources |
| | Cross-account pooling |
| | IT Architecture, etc. |
| Inflexible Constraints | Regulatory and legal |
| | Business Policies |
| | Performance |

The flexible constraints and inflexible constraints can also be scored during the initial assessment stage. The score can be used to determine which flexible and inflexible constraints can be modified in order to provide business solutions.

The assessment tool 100 can also provide technical specifications and value drivers for business solutions based on the complete client operational assessments. For example, the assessment tool 100, in the complete client operational assessment stage, can determine the client maturity and transition and transformation risk for specific areas such as, for example, servers, storage, mainframe, end user services, etc., where process maturity questions are mapped to associated drivers of value and technical specifications.

More specifically, in embodiments, the complete client operational assessment utilizes the scores from questions in an assessment that are aligned to one or more drivers of value and technical specifications. Generally, the scores can be calculated by an average score for each driver of value as discussed in more detail below. As a result of the complete client operational assessment, each question in the client operational assessment can be related to one or more drivers of value and one or more technical specifications (solutions). This produces a relationship wherein the value of various elements that are used to calculate a specific average score for the drivers of value are the same as those used to calculate a specific average score for the technical specifications. In effect, there can be an intersection between questions associated with particular drivers of values and questions associated with particular technical specifications, in order to provide business solutions. These business solutions can then be generated as a report by the report tool 105.

In embodiments, the storage system 22B can maintain a list of questions and related answers associated with the Lean components and Lean capabilities, as well as the constraints. The storage system 22B can also include scores associated with answers, as well as the average scores, e.g., maturity levels, provided by the assessment tool 100. In addition, the storage system 22B can maintain a list of the questions and related answers associated with the complete client operational assessment, and related scores as determined by the assessment tool 100. In addition, the storage system 22B can maintain the reports, as generated by the report tool 105, as well as any report templates. For example, the reports can be, for example, based on standardized formats that are stored in the storage system 22B. It should be understood by those of skill in the art that the storage system 22B can also store other information, as described herein, e.g., correlations between maturity levels and technical specifications, and that the above list is merely an illustrative example of information stored in the storage system 22B. It should also be understood by those of skill in the art that the storage system 22B can be multiple storage systems, as discussed below.

The computing device 14 can comprise any general purpose computing article of manufacture capable of executing computer program code installed thereon (e.g., a personal computer, server, etc.). However, it is understood that the computing device 14 is only representative of various possible equivalent-computing devices that may perform the processes described herein. To this extent, in embodiments, the functionality provided by the computing device 14 can be implemented by a computing article of manufacture that includes any combination of general and/or specific purpose hardware and/or computer program code. In each embodiment, the program code and hardware can be created using standard programming and engineering techniques, respectively.

Similarly, the computing infrastructure 12 is only illustrative of various types of computer infrastructures for implementing the invention. For example, in embodiments, the server 12 comprises two or more computing devices (e.g., a server cluster) that communicate over any type of communications link, such as a network, a shared memory, or the like, to perform the process described herein. Further, while performing the processes described herein, one or more computing devices on the server 12 can communicate with one or more other computing devices external to the server 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

### Component Level Architecture

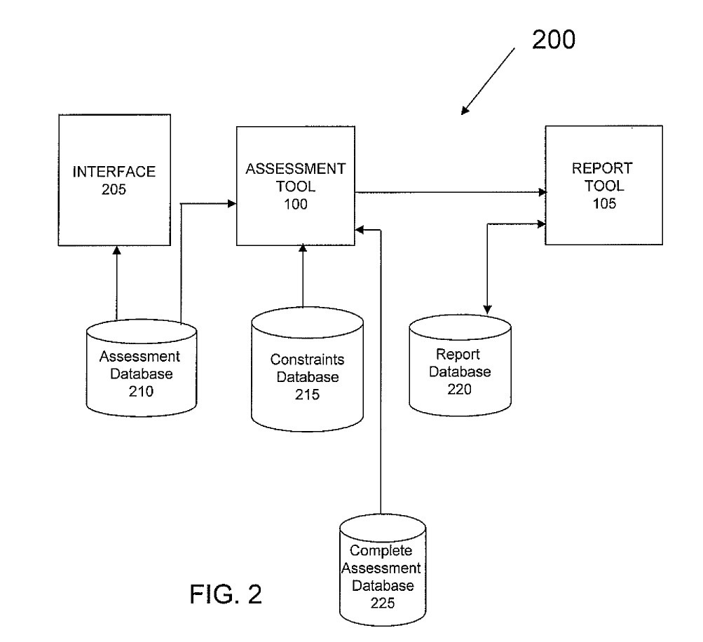

FIG. 2 shows an exemplary component level architecture in accordance with aspects of the present invention. In embodiments, the component level architecture 200 includes a user interface 205. The user interface 205 can be, for example, a display device of a computing system such as, for example, a desk top computer, a laptop computer and/or a portable digital assistant, connected to the infrastructure of FIG. 1, in any manner discussed herein, e.g., LAN, WAN, wireless, etc.

The component level architecture 200 also includes several databases including, for example, an assessment database 210, a constraints database 215 and a report database 220. Also, in embodiments, a complete client operational assessment database 225 may include additional information, for the complete client operational assessment stage. In embodiments, the assessment database 210, constraints database 215, report database 220 and complete client operational assessment database 225 may be a single database or any combination of databases.

In implementation, the assessment database 210 includes a plurality of questions and answers that are related to the initial assessment stage and complete client operational assessment stage. For example, using the initial assessment as an illustrative example, the assessment database 210 would include questions, answers and associated scores related to Lean components and Lean capabilities. The answers to each of the questions are associated with a score that was provided by a service provider such as, for example, a consultant. The questions and related answers and scores for the complete client operational assessment stage can be more granular, e.g., specific, and can be more focused based on the composite scores for each of the Lean capabilities and/or components, for example.

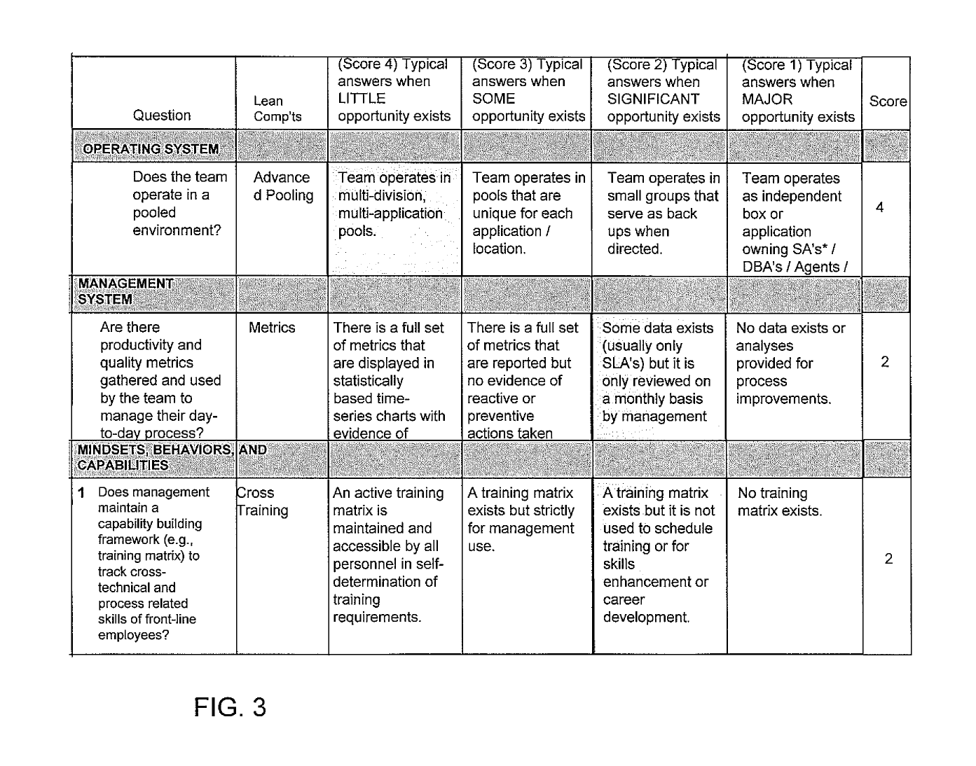

By way of more specific example, FIG. 3 shows three Lean components with a question related to particular Lean capability of the Lean component. Each of the particular questions includes a plurality of answers, e.g., four answers. In turn, the answers are each provided with a score from 1-4, with 4 being the highest.

As even more specifically shown in FIG. 3, each of the answers are scored from “1” through “4”, where a score of “4” indicates a high maturity level for a particular Lean capability. That is, a score of “4” indicates that there is little, if any improvement, opportunity to increase business value. On the other hand, a score of “1”, which is a low score, is indicative of a need for improvement in such Lean capability. Accordingly, as the table below shows, lower scores indicate higher potential:

| Score between | Value |
|---|---|
| 1-2 | High potential opportunity |
| 2-3 | Medium potential opportunity |
| 3-4 | Low potential opportunity |

It should be understood, though, that more or less questions, with a different scoring system is also contemplated by the present invention, and the questions and related answers and scores shown in FIG. 3 are merely provided as an illustrative example. For example, upwards of 50 questions may be provided in a typical initial assessment stage. In implementation, the questions and related answers can be provided to a user, e.g., business, on the interface 205.

The constraints database 215 includes a plurality of questions and answers that are related to the flexible and inflexible constraints. For example, during the initial assessment stage, the constraints database 215 can present questions and related answers to the user via the interface 205. For example, questions, answers and associated scores can be related to different business, regulatory and/or legal constraints, amongst others. The answers to each of the questions (related to the constraints) are associated with a score that was provided by a service provider such as, for example, a business consultant.

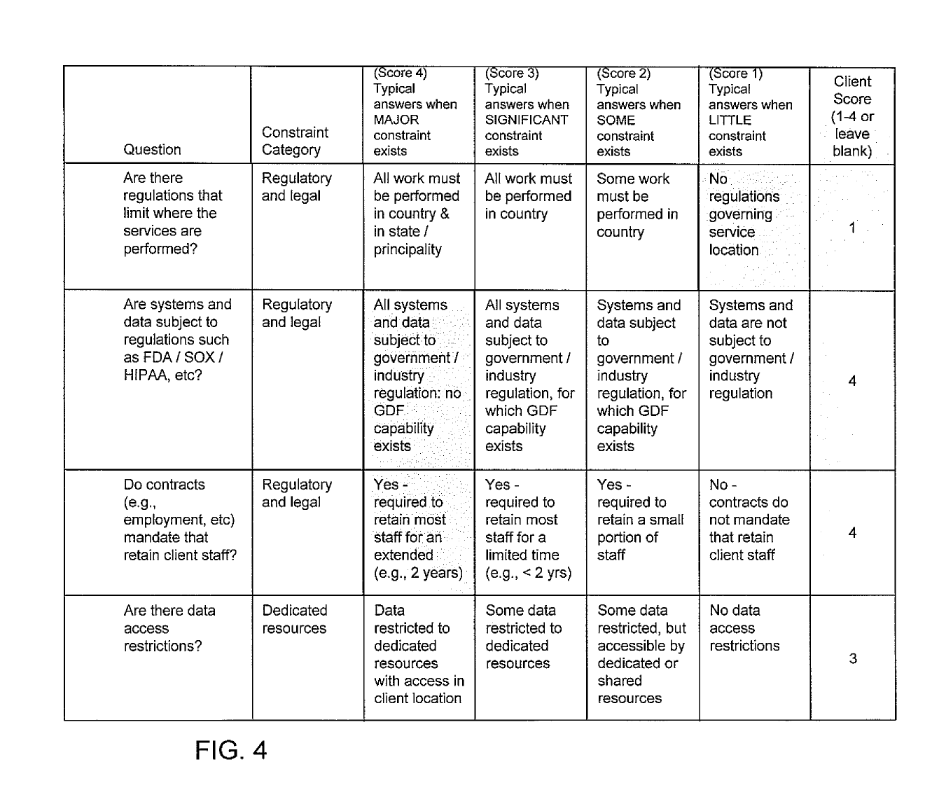

By way of more specific example, FIG. 4 shows a table of constraint categories with related questions, answers and scores in accordance with aspects of the present invention. In this illustrative, non-limiting example, the constraint categories can be regulatory and legal, as well as dedicated resources. Each of the particular questions includes a plurality of answers, e.g., four answers. In turn, the answers are each provided with a score from 1-4, with “4” being indicative of a major constraint. A major constraint may be a constraint which cannot be changed by the business. On the other hand, a score of “1” may be indicative of a minor constraint, e.g., a constraint that can easily be changed by the business. It should be understood, though, that more or less questions, with a different scoring system is also contemplated by the present invention, and the questions and related answers and scores shown in FIG. 4 are merely provided as an illustrative example.

Referring back to FIG. 2, once all of the questions are answered and a score assigned thereto, the assessment tool 100 can then compile the scores and provide an overall score for each of the categories and/or constraints, for example, in the initial assessment stage. This may be performed by averaging all of the scores for each category and component, or may be provided as a weighted average. For example, different categories can be weighted differently, depending on their importance to an overall business solution or strategy. Illustratively, scores related to IT infrastructure may be important for a service related company and, as such, any Lean capabilities associated with, e.g., servers, computers, or other IT infrastructure, may be weighted more than Lean capabilities of pooling.

The assessment tool 100 can tabulate an overall score for any component, set of components, capabilities, set of capabilities, constraints, etc. in order to provide an overview of business values during the initial assessment stage. In the complete client operational assessment stage, the assessment tool 100 can provide additional, more granular questions, to determine business drivers and more specific solutions, e.g., technical specifications. For example, at an initial assessment stage, the tabulated results may be used to provide a high-level assessment and strategy for improving certain business processes, infrastructure, etc., or to provide a generally understanding of the needs for improvement by the business. On the other hand, at a complete client operational assessment stage, the tabulated results may be used to provide very thorough and specific business solutions, e.g., drivers of value, in response to certain business needs.

The report database 220 can save the reports for future reference and/or review and/or analysis. By way of a non-limiting illustrative example, TABLE 3 shows a report generated in response to an initial assessment related to the Lean component of operating systems. TABLE 4 shows a report generated in response to an initial assessment related to the Lean component of management. TABLE 5 shows a report generated in response to an initial assessment related to the Lean component of business mindsets, etc. TABLE 6 shows an overall composite score, which may be weighted, after completion of the initial assessment stage. Other reports can be generated, in a similar manner, related to, for example, flexible and inflexible constraints, as well as specific solutions obtained after evaluation of the complete client operational assessment stage.

TABLE 3

| OPERATING SYSTEM | 2.3 |
|---|---|
| Advanced Pooling | 4.0 |
| Banding | 4.0 |
| Dispatching | 2.0 |
| Flexible Work Structures | 1.0 |
| Process maturity and standardization | 1.8 |
| Defect prevention | 1.0 |

TABLE 4

| MANAGEMENT | 2.7 |
|---|---|
| SYSTEM | |
| Metrics | 2.0 |
| Performance Management | 3.0 |
| Span of control | 3.0 |

TABLE 5

| MINDSETS, | |
|---|---|
| BEHAVIORS & | |
| CAPABILITIES | 1.5 |
| Cross Training | 1.5 |
| Continual Improvement | 2.0 |
| Problem-solving | 1.5 |
| Role-modeling | 1.0 |

TABLE 6

| OVERALL (NON-WEIGHTED) | |
|---|---|
| SCORE | 2.2 |
| Operating system | 2.3 |
| Management system | 2.7 |
| Mindsets, behaviors, and capabilities | 1.5 |
| WEIGHTED PRODUCTIVITY | 2.3 |
| SCORE | |
| WEIGHTED QUALITY SCORE | 2.2 |

As thus shown in the above reports (or tables), each of the Lean capabilities can be provided with an overall score, associated with each of the Lean components. The Lean components can then be provided with a composite score based on the scores of the Lean capabilities. The composite scores can then be tabulated into an overall report as shown in TABLE 6. In embodiments, a score of 1-2 represents a potential for high impact on business value, e.g., need for improvement. A score of 2-3 represents a potential for medium impact on business value. A score of 3-4 represents a potential of low impact on a business value. It should be understood that these scores and related impact on business value is only an illustrative example. Other scoring systems can also be used with the present invention such as, for example, a score of 1-10.

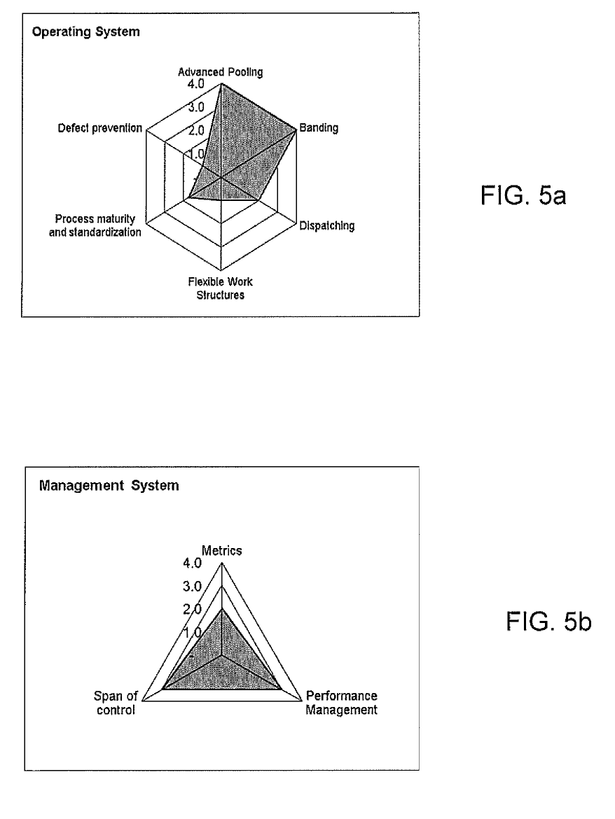

The report tool 105 and/or the assessment tool 100 can provide an overall score, e.g., 2.2, based on the composite scores of each of the components. The report tool 105 and/or the assessment tool 100 can also provide a weighted score based on the quality and productivity gains which can be obtained by making improvements to the Lean components. For example, low quality and productivity scores suggest potential to select more transformative initial offerings as a starting point for a business solution. Also, in embodiments, a low productivity and quality scores suggests emphasizing messages around both labor efficiencies and improved quality. In embodiments, the report tool 105 can also generate graphical representations of the tables. For example, TABLES 3, 4, and 5 are shown graphically in FIGS. 5a-5c, respectively.

The complete client operational assessment database 225 may include information required for the complete client operational assessment stage. For example, the complete client operational assessment database 225 may include values and technical specifications, as well as correlation information. The values and technical specifications that are mapped to certain scores, and correlation information can be information that correlates the score to a business solution. More specifically, the technical specifications may be suggested solutions for making improvements to a business. These technical specifications can range from, for example, the number of servers required to maintain certain efficiencies, reallocation of resources, amongst numerous other solutions. The value drivers (also referred to as drivers of value) may be, for example, an importance or significance level placed on each of the technical specifications for the business. On the other hand, the correlation information may be mapping factors, which correlate a certain score to a certain solution, e.g., technical specification.

### Flow Diagram

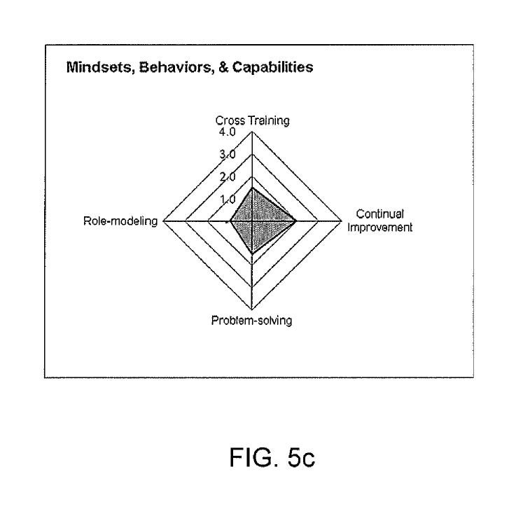

FIGS. 6-8 show an exemplary flow for performing aspects of the present invention. The steps of FIGS. 6-8 may be implemented in the environment of FIG. 1 and/or the component architecture of FIG. 2, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Furthermore, the invention can take the form of a computer program product accessible from a computer-usable or computer-readable medium providing program code for use by or in connection with a computer or any instruction execution system. The software and/or computer program product can be implemented in the environment of FIGS. 1 and/or 2. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disc—read/write (CD-R/W) and DVD.

FIG. 6 depicts an exemplary swim lane diagram showing processing steps in accordance with aspects of the present invention. More specifically, FIG. 6 shows a flow for an initial assessment stage in accordance with aspects of the invention, with three players: a client (business), a consultant (e.g., service provider) and technologies (e.g., assessment tool, report tool and related databases and components). The initial assessment focuses on a client's process maturity, and business and environment constraints. The initial assessment may be provided before qualification, e.g., earlier in the process, but can be applied across different stages of an engagement (e.g., including post-qualification) to generate useful insight. The initial assessment can address:
Full client access—Utilize a consultative approach, with structured process and interviews to provide early transition/transformation planning.
Limited client access—Utilize an opportunistic approach, collecting information as available.

The Initial assessment can also be used to influence the preparation of a request for proposal contents by emphasizing a process focus and sharing recommendations drawn from the output of the initial assessment. The initial assessment can also focus on understanding a client's operational environment to create higher-quality solutions, and to provide a single repository for information about the client that is used by teams throughout the engagement process.

At step 600, the client or business customer recognizes a need to improve their business such as, for example, IT delivery, and requests an analysis of their environment as part of a proposal development. At step 605, the client provides access to personnel and/or information. In embodiments, for example, the client or business customer provides names and access to the key personnel (e.g., subject matter experts, practitioners, etc.) required to provide information for the assessment.

At step 610, the consultant can begin the process of scheduling interviews. For example, the consultant schedules interview meetings with the key personnel. At step 615, the consultant conducts an initial assessment interview(s), discussing and rating the process maturity of the client's IT organization as well as overall IT environment and other business operations. At step 620, the consultant also observes the business operations and reviews any additional information. For example, the consultant observes the IT organization in practice and reviews information (e.g., which may include operational documentation, public information, prior engagements, RFP (Request for Proposal) specifications, etc.) to provide additional insight into the client's organization and/or business practices. At step 625, the consultant enters the results into the tool of the present invention, e.g., assessment tool 100. For example, the consultant can update the assessment tool with the assessment and environment results.

At step 630, the assessment tool correlates the assessments to Lean components. At step 635, the assessment tool correlates the environment, for example, to business constraints, e.g., flexible and inflexible constraints. That is, the assessment tool correlates the environment results to the appropriate business constraints. At step 640, the assessment tool returns areas of improvement opportunity. For example, the assessment tool scores the Lean components and constraints, and provides a score documenting the components that have the greatest improvement opportunity as well as the constraints.

At step 645, the consultant and/or assessment tool develops improvement strategies to address identified needs and constraints. For example, the consultant and/or assessment tool uses the score to develop a strategy to address the clients IT delivery or other business operations and/or processes. As this is the initial assessment, the strategies are high-level solutions correlated to identified business issues in order to generate strategy proposals, i.e., the strategies are intended to provide a general roadmap for further assessment and solutions. At step 650, the consultant provides the proposed strategy to the client for approval. At step 655, the client receives the strategy briefing and provides a decision to proceed, or requests further analysis. As the strategy was developed to address the immature points in their IT delivery, likely acceptance of the strategy can be assured; however, if not initially accepted, the process can revert back to step 615 or step 620, for example.

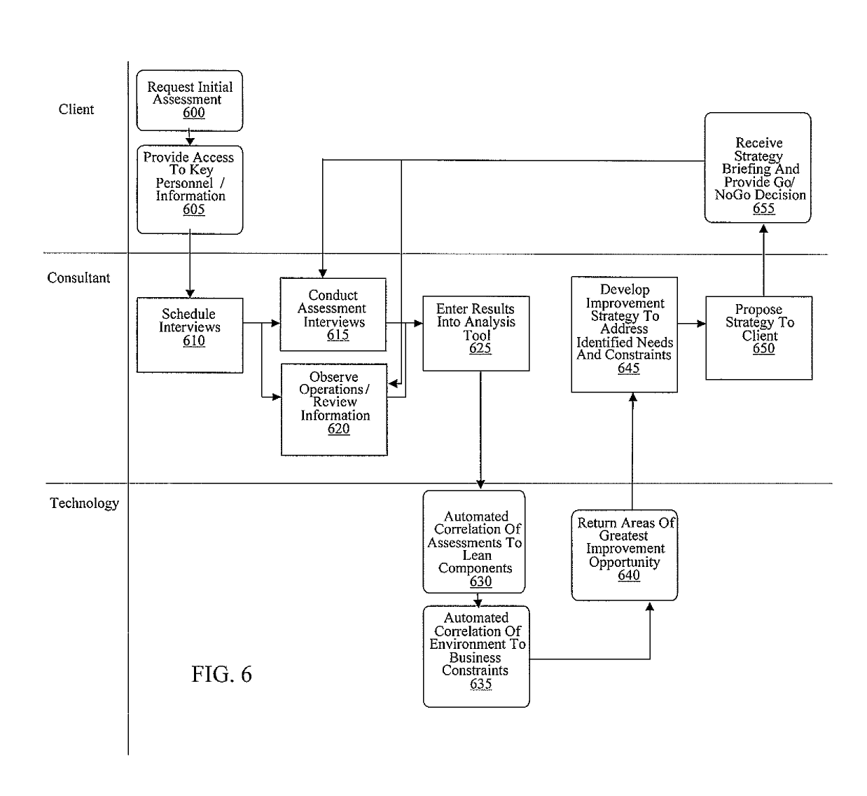

FIG. 7 shows a swim lane diagram showing processing steps for a complete client operational assessment stage in accordance with aspects of the invention. The swim lane diagram, much like that in FIG. 6, includes three players: a client (business), a consultant (e.g., service provider) and technologies (e.g., assessment tool, report tool and related databases and components). At step 700, the client requests a detailed assessment, based on an initial assessment stage. For example, the client has accepted the proposed initial strategy, and requests a detailed assessment to develop the targeted solution. At step 705, the client provides access to personnel and/or business information. For example, the client or business customer provides names and access to key personnel (e.g., subject matter experts, practitioners, etc.) required to provide information for the assessment.

At step 710, the consultant schedules interview meetings with the key personnel. At step 715, the consultant conducts the assessment interviews, discussing and rating the process maturity of the client's IT organization as well as transition risks (e.g., issues that may develop as a result of changes made to the organization) and other related matters associated with the business.

In embodiments, the questions presented during the complete client operational assessment stage may be related to any technology or business operation/process. For example, the questions may be related to any IT infrastructure such as, for example, storage requirement. Also, the questions presented at the complete client operational assessment stage may be linked to answers and/or scores obtained during the initial assessment stage. For example, questions related to servers may be presented in the complete client operational assessment stage, since it was determined during the initial assessment stage that there was a value to the business to update server technology. More specifically, questions may relate to server requirements such as, for example:
Do you currently use cloud computing?
Do you have unique response time requirements?
Do you have any critical servers that must be continuously available?

At step 720, the consultant observes the business operations and reviews any additional information. For example, the consultant observes the IT organization in practice and reviews information to provide additional insight into the client's IT organization. At step 725, the consultant enters the results into the assessment tool. For example, the assessment tool can be updated with the assessment and any transition risk results.

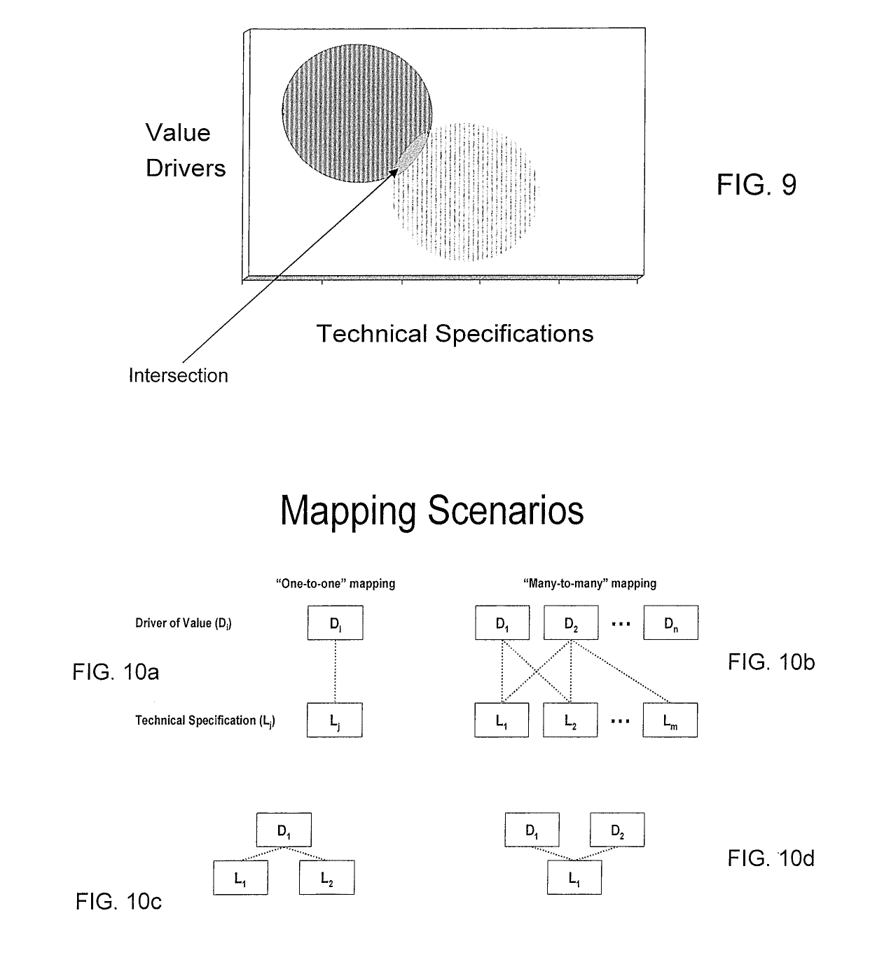

At step 730, the assessment tool correlates the assessment results to the appropriate value drivers for the business. This correlation can be a “one-to-one”, “one-to-many” or “many-to-one” relationship as discussed in more detail with reference to FIGS. 10a-10d. It should be understood by those of skill in the art that value drivers may include, for example, any category that would increase the value to the business. These value drivers may include, amongst other drivers:
Quality;
Risk Management Issues;
Business (Industry) and Technology Expertise;
Financial Value; and
Scalability of IT, e.g., adaptability and flexibility.

At step 735, the assessment tool provides an automated identification of technical specifications based on value driver results. For example, the assessment tool scores the value drivers (based on answers provided by the client) and, based on the score, identifies the technical specifications that can address the value drivers to provide real business value. The questions and answers can be formatted and scored similar to the answers and tables/reports in the initial assessment stage. For example, different questions can be associated with the value drivers, with each question having an answer. In turn, each answer can be provided with a score, e.g., 1-4, which can then be averaged by the assessment tool, for each of the drivers. The tabulated scores can also be weighted and correlated to technical specifications (opportunity levers), e.g., solutions that would add value to the business. These solutions can be technical specifications that increase efficiency, etc.

At step 740, the assessment tool returns areas of greatest opportunity (e.g., prioritized technical specifications). For example, the assessment tool returns the value driver results, the technical specifications, and identifies those value drivers and technical specifications that provide the area of greatest opportunity, which may be provided by highlighting those values. That is, using, for example, the complete client operational assessment database 225, the technical specifications can be mapped to certain scores, and correlated to business solutions.

The technical specifications may be suggested solutions for making improvements to a business. By way of more specific examples, the difference between the “quality score” for the client's current environment and the service provider's best practices indicates the ability to drive higher quality through capabilities such as defect prevention. In evaluating industry expertise, low scores for “mindsets, behaviors, and capabilities” and “cross-training” component can indicate that the service provider can provide the client with access to practitioners with high and ever-improving skills and technical knowledge. Clients with a low score in the operating system “flexible work structures” component may have difficulty dealing with peaks in workload, and could benefit from the flexibility in labor structure. In evaluating risk management, operating systems with low “defect prevention” and “standardization” scores can benefit from the ability to identify and mitigate risks. Also, in evaluating financial value, a low “management system” score indicates that the possibility of improvement visibility and oversight of IT through metrics and performance management.

TABLE 7 shows overall scores for each of the value drivers. In embodiments, the overall score for each of the value drivers may be based on an average of scores assigned to individual answers for each question associated with the value drivers. Each of these overall scores can then be translated into an overall value (non-weighted or weighted). The non-weighted score may be an average of the overall scores for the value drivers. In addition, each of the overall scores can be used to provide a priority, e.g., which value drivers should be addressed in a specific order of importance or value. A low overall value signifies “High” potential opportunity for providing valuable business solutions.

TABLE 7

| Priority | Overall Value (non-weighted) | 2.1 |
|---|---|---|
| 1 | Quality | 1.8 |
| 5 | Expertise | 2.0 |
| 4 | Adaptability/Flexibility | 2.5 |
| 3 | Risk management | 2.5 |
| 2 | Financial Value | 1.9 |
| | Weighted Score | 2.1 |

At step 745, the consultant develops a targeted solution mapped to client value using the technical specifications. For example, the consultant uses the technical specifications to develop the targeted solution to improve client value results and, hence, provide business value. At step 750, the consultant can perform a bottom up estimation of the solution cost based on the workload drivers. This may be performed by the database 225, by mapping certain solutions to known costs. At step 755, the consultant provides the proposed solution and cost, as well as the rational and business value, to the client for their review. At step 760, the client receives the solution and cost, and approves or rejects the solution. Further negotiations can take place as well as solution refinement before a final contract is signed by, for example, reverting back to either steps 715 or 720.

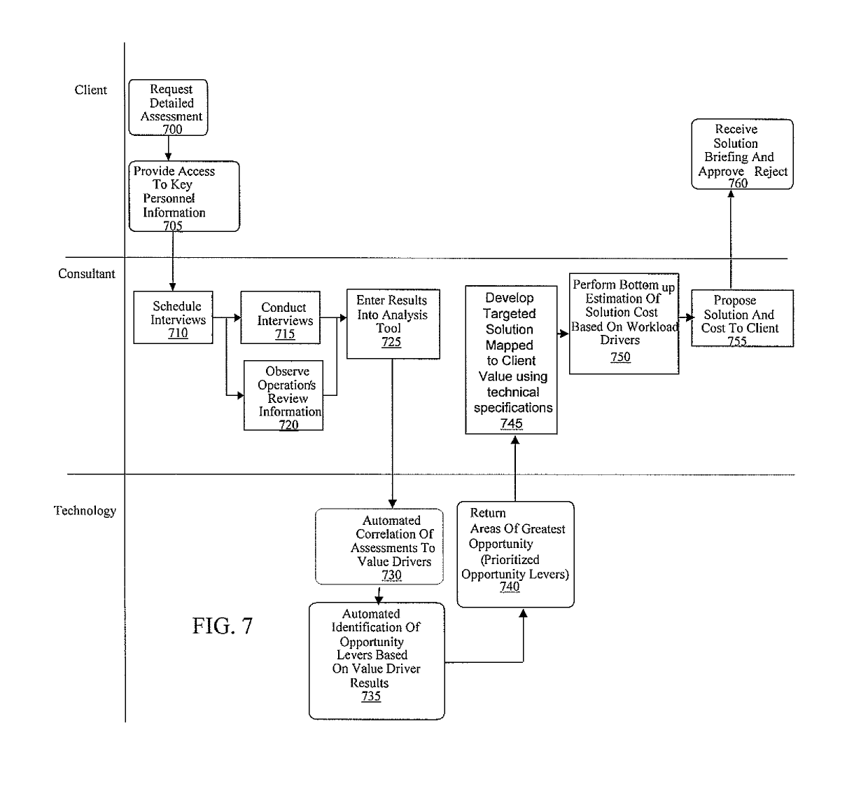

FIG. 8 shows further processing steps related to steps 730 and 735 of FIG. 7, in accordance with aspects of the present invention. More specifically, at step 800, the assessment tool imports assessment scores from the assessment database. At step 805, the assessment tool associates the related value drivers to the scores. At step 810, the assessment tool associates related opportunity levers (e.g., also referred to as technical specifications or specifications of a solution) to the scores. For example, opportunity levers can be related to technology, organization and operations and business environments. These levers may include, but not limited to:
Standardization/optimization of products;
Testing optimization;
Business continuity;
Virtualization;
Converged server network;
Data movement;
Optimization of server infrastructure;
Managing massive and widely distributed environment;
Standardization/automation analysis;
Global delivery framework;
Addressing growth;
Cloud/computing demand;
Software compliance;
Software security; and
Energy efficiency.

At step 815, the assessment tool identifies mapping between drivers of value and the opportunity levels. In embodiments, the drivers of value may include, for example:
Data rationalization;
Optimize unit cost (hardware/software);
Maximize utilization;
Minimize labor costs,
Minimize power costs;
Minimize floor space/facility costs;
Increase uptime with proactive trend analysis;
Minimize performance impact of data migrations rations movement,
Optimize access time,
Optimize backup/recovery,
Provide industry-leading technical sophistication and skill sets;
Increase scalability with rapid scale-up/down solutions;
Ensure compliance requirements are met;
Protect sensitive data; and
Reduce provisioning time.

At step 820, the assessment tool calculates an average score for each driver of value, D̅i using, for example, the following equation:

$${\overline{D}}_{i} = \frac{1}{{ξ}_{i}} {\sum }_{k = 1}^{t} {w}_{k}^{( i , 0 )} \cdot {M}_{k}^{( i , 0 )} \cdot {q}_{k} \qquad ( 1 )$$

where ω^{(i,0)} is a weighting factor for the question scores associated with the ith driver of value, Mₖ^{(i,0)} is 1 for questions that impact the driver of value and 0 otherwise, ξi represents the number of non-zero elements associated with each driver of value, i, t is the total number of questions in the assessment, and qₖ represents the score for each question.

At step 825, a determination is made as to whether there are any more drivers. If so, the process reverts back to step 820. If not, the process continues to step 830, where the assessment tool calculates the average score for each specification of a solution, L̅ⱼ, as follows:

$${\overline{L}}_{j} = \frac{1}{{ζ}_{j}} {\sum }_{k = 1}^{t} {w}_{k}^{( 0 , j )} \cdot {M}_{k}^{( 0 , j )} \cdot {q}_{k} \qquad ( 2 )$$

where ζⱼ represents the number of non-zero elements associated with each driver of value, j, Mₖ^{(0,j)} is 1 for questions that impact the technical specification (i.e., opportunity lever) and 0 otherwise, and qₖ represents the score for each question. As should now be understood by those of skill in the art, all questions that are associated with a technical specification are considered levers.

The underlying construct for the system of equations represents a set of questions that is aligned to both one or many drivers of value and technical specifications. This can be represented as follows:

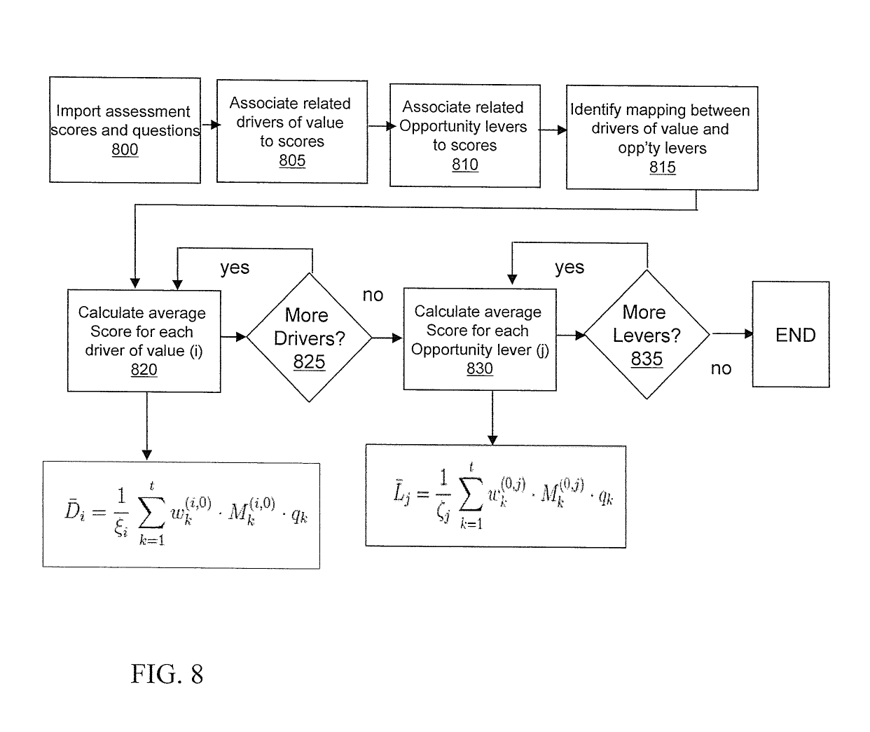

A={Q|D,L}

where A denotes the set of all questions Q having properties of both drivers of value D, and specifications of a solution L. As a result, each question in the complete operational assessment is related to one or more drivers of value and one or more technical specifications. This produces a relationship wherein the value of various questions that are used to calculate a specific average score for the drivers of value are the same as those used to calculate a specific average score for the technical specifications. In effect, there is an intersection between questions associated with particular drivers of value and questions associated with particular technical specifications, as shown in FIG. 9.

More specifically, if B represents the set of questions aligned to the drivers of value B={Q|D}) and C represents the set of questions aligned to the technical specifications (C={Q|L}), then:

B∩C={q|qεB and qεC}

where B∩C is a set of questions common to both B and C.

It should also be understood by those of skill in the art that the relationships between value drivers and technical specifications are not simply one to one as shown in FIG. 10a. For example, as shown in FIG. 10b, the relationships may be mapped as many-to-many. In the case of many to many relationships, multiple technical specifications of a solution can produce an impact on a business which is described by a driver of value as shown in FIG. 10b. Also, as shown in FIG. 10c, a single technical specification can impact multiple drivers of value, since a technical specification can have broad impacts across many different dimensions.

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In view of the above, it becomes evident and clear that the present invention provides many advantages over conventional models and methodologies. For example, the present invention provides:
consistent insight into an operational environment of a business, enabling teams to capture and share information regarding the process maturity and operational environment;
consistent methodologies that support a different technical dialogue with the client that is focused on processes rather than, for example, only physical infrastructure such as, for example, counts of servers, storage devices, etc;
automated identification of technical specifications and value drivers that address and provide real business value to the client; and
a structured approach to identify sources of value specific to a client's operational environment.

In addition, the present invention provides improved coordination/standardization by utilizing standard, well-defined offering structures, as well as solutioning content which enables frontend standards and links to backend processes such as, for example, sales and/or delivery linkages. The present invention can also be updated to in-scope delivery capabilities. Moreover, the present invention provides an improved and streamlined methodology to provide faster, efficient and more complete evaluations for opportunities by providing a streamlined and integrated approach that supports the creation and development of solutions to provide services to clients, and provides improved generation of information for sales and marketing, as well as solutions, transition and transformation early in the business engagement cycle.

Also, the present invention provides faster transition to steady state, enabled by achieving greater insight earlier in the process into the client's current operational environment and desired end state requirements and identification of potential risks for early planning stages. By also providing a more efficient methodology of business evaluation, it is also possible to reduce engagement-to-close time, which can lead to increased customer satisfaction. The client also receives a compelling value proposition, at an early stage, making the case for improvement (e.g., change) in the business drivers. The present invention also allows the service provider, e.g., consultant to differentiate their solution though capabilities, experiences and how services are delivered, at an early stage, while providing objective business outcomes and performance metrics.

### Illustrative Examples

The following is an illustrative example which implements the processes and tools of the present invention. Although the following example shows two questions, it should be understood that more questions may be presented to the client. For example, in an illustrative example, a typical assessment may contain about 50 questions, but there is no inherent size limitation as to the number of questions contained in an assessment. In addition, different technology platforms (i.e., Mainframe, Storage, etc.) can have their own individual assessments. Within the assessment, each answer to a question corresponds to a different level of maturity, with the first answer (A1) assigned a score of 1 representing an environment reflective of a fairly low operational maturity and the fourth answer (A4) assigned a score of 4 representing a high operational maturity. In this example, an assessment contains the following questions and possible answers.

### Question

Q1: Do you “shred” (electronically) personal and corporate data that regulations no longer require you to maintain or whose misplacement could hurt your company's reputation?

### Possible Answers

A1 (score=1): Client maintains or archives everything indefinitely.

A2 (score=2): Client maintains or archives all compliance related records indefinitely.

A3 (score=3): Client maintains or archives compliance related records for a set period of time that may or may not exceed regulations.

A4 (score=4): Client closely manages compliance related records, personal, and corporate data to make sure that no document is held longer than required.

### Question

Q2: How do you handle the encryption of important data archived to tape?

### Possible Answers

A1 (score=1): Client does not encrypt tape or disk.

A2 (score=2): Client has multiple tape back-up solutions and some archives are encrypted.

A3 (score=3): Client encrypts all tape back-ups and has considered (but not implemented) full disk encryption for confidential data stores.

A4 (score=4): Client encrypts all tape back-ups and has implemented full disk encryption for confidential data stores.

A consultant would gather information from the client through direct conversation, prior dealings, information issued by the client (e.g., requests for proposal), etc. The consultant would utilize this information to identify the appropriate answer for each question in the assessment form, entering a “1”, “2”, “3”, or “4” in a specific entry field corresponding to the selected answer. The assessment form then automatically highlights the text for the selected answer, e.g., bolds or colors the column, allowing for easy identification of the selected answer for each question as shown in the below:

| | Answer | Answer | ANSWER | Answer | |
|---|---|---|---|---|---|
| Question | Score 1 | Score 2 | SCORE 3 | Score 4 | Score |
| How do you | Client | Client has | CLIENT | Client | 3 |
| handle the | does not | multiple tape | ENCRYPTS ALL | encrypts all | |
| encryption of | encrypt | back-up | TAPE BACK- | tape back- | |
| important data | tape or | solutions and | UPS AND HAS | ups and has | |
| archived to | disk. | some archives | CONSIDERED | implemented | |
| tape? | | are encrypted. | (BUT NOT | full disk | |
| | | | IMPLEMENTED) | encryption | |
| | | | FULL DISK | for | |
| | | | ENCRYPTION | confidential | |
| | | | FOR | data stores. | |
| | | | CONFIDENTIAL | | |
| | | | DATA STORES. | | |

In this example, the consultant is evaluating a client that has an environment in which the client maintains archives for a set period of time that may or may not exceed regulations, and the client does not encrypt tape or disk. This results in an assessment score for question 1 of 3 (Q1=3) and question 2 of 1 (Q2=1). These scores are then imported into the assessment tool that derives the average scores by drivers of value and opportunity levers.

To calculate the average driver of value and opportunity lever scores, each question in the tool is mapped to distinct drivers of value and opportunity levers. In the present case, for example, Q1 and Q2 the assessment tool can be aligned to the “Protect data” driver of value as part of the “Risk Management” dimension of value. Q1 can also be aligned to the opportunity levers of “Software to manage regulatory compliance” and “Software to manage data security and encryption issues”; whereas Q2 can be aligned to the “Software to manage data security and encryption issues” opportunity lever. The assessment tool calculates the averages for the driver of value and opportunity lever as follows:

Drivers and Dimensions of Value
Average score for the “Protect data” driver of value=(3+1)/2=2
Average score for the “Risk Management” dimension of value=average of the scores for the associated drivers of value. In this case, the average score for “Risk Management”=2, since there is only one driver of value associated with this dimension of value.

Opportunity Levers
Average score for the “Software to manage regulatory compliance” opportunity lever=3
Average score for the “Software to manage data security and encryption issues” opportunity lever=(3+1)/2=2

These maturity scores correspond to potential opportunity to improve the client's environment and drive higher value; in essence, if a client has an environment with low maturity, there is the opportunity to improve that environment through the use of best practices and capabilities of the service provider or other planned strategies.

The assessment tool presents the consultant with the averages for the drivers of value and opportunity levers. This allows the consultant to see that the opportunity lever, for example, “Software to manage data security and encryption issues” has the greatest impact to improve the “Protect data” driver of value. The consultant can then use this knowledge as they create and refine a solution to meet the client's needs, incorporating “Software to manage data security and encryption issues” into the solution to most strongly influence improvement of data protection and risk management, if warranted given the client's situation and desires.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims, if applicable, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principals of the invention and the practical application, and to enable others of ordinary skill in the art to understand the invention for various embodiments with various modifications as are suited to the particular use contemplated. Accordingly, while the invention has been described in terms of embodiments, those of skill in the art will recognize that the invention can be practiced with modifications and in the spirit and scope of the appended claims.

What is claimed is:

1. A method implemented in a computer infrastructure having computer executable code tangibly embodied on a computer readable storage medium having programming instructions operable to:
provide an initial assessment of business operations, using a framework based on lean capabilities and lean components, as well as at least one of business and environmental constraints;
determine a need for improvement based on scores provided in the initial assessment; and
provide a complete assessment using business drivers and specifications of a solution to identify areas for improvement of business operations.

2. The method of claim 1, further comprising formulating an initial proposal and business strategy to address improvement needs based on the initial assessment.

3. The method of claim 1, wherein the lean capabilities include operating systems, management systems, and behavioral components.

4. The method of claim 3, further decomposing the lean capabilities into lean components and assessing their maturity level during the initial assessment, wherein the maturity level is based on a score assigned to answers related to particular questions aligned to the lean components.

5. The method of claim 1, wherein the business and environment constraints are categorized as flexible and inflexible constraints.

6. The method of claim 1, wherein the complete assessment includes providing the specifications and value drivers for business solutions.

7. The method of claim 6, wherein the complete assessment includes transition and transformation risk for specific business areas.

8. The method of claim 1, wherein the complete assessment utilizes a mapping that links one or more drivers of value and one or more of the specifications of a solution.

9. The method of claim 8, wherein the scores for the one or more drivers of value are calculated as a weighted average of one or more questions associated with the driver of value, and the scores for the specifications of a solution are calculated as a weighted average of the one or more questions associated with the specification of a solution

10. The method of claim 9, wherein the providing the complete assessment comprises:
calculating an average score for each of the one or more drivers of value, D̅i̅, as follows:
$${\overline{D}}_{i} = \frac{1}{{ξ}_{i}} {\sum }_{k = 1}^{t} {w}_{k}^{( i , 0 )} \cdot {M}_{k}^{( i , 0 )} \cdot {q}_{k} \qquad ( 1 )$$
where ω^{(i,0)} is a weighting factor for the question scores associated with the ith of value, Mₖ^{(i,0)} is 1 for questions that impact the driver of value and 0 otherwise, ξi represents a number of non-zero elements associated with each driver of value, i, t is a total number of questions in an assessment, and qₖ represents the score for each question; and
calculating an average score for each of the technical specifications, L̅ⱼ, as follows:
$${\overline{L}}_{j} = \frac{1}{{ζ}_{j}} {\sum }_{k = 1}^{t} {w}_{k}^{( 0 , j )} \cdot {M}_{k}^{( 0 , j )} \cdot {q}_{k 1} \qquad ( 2 )$$
where ζj represents a number of non-zero elements associated with each driver of value, j, and Mₖ^{(0,j)} is 1 for questions that impact the technical specification (i.e., opportunity lever) and 0 otherwise,
wherein an underlying construct for the equations represents a set of questions that is aligned to both the one or more of the drivers of value and the technical specifications as represented by:
A={Q|D,L}
where A denotes a set of all questions Q having properties of both the one or more drivers of value D, and the technical specifications, L;
wherein if B represents the set of questions aligned to the one or more drivers of value B={Q|D}) and C represents the set of questions aligned to the technical specifications (C={Q|L}), then:
B∩C={q|qεB and qεC}
where B∩C is a set of questions common to both B and C.

11. The method of claim 1, wherein a service provider at least one of creates, maintains, deploys and supports the computer infrastructure.

12. The method of claim 1, wherein steps of claim 1 are provided by a service provider on a subscription, and/or fee basis.

13. A system implemented in hardware, comprising:
an assessment tool operable to provide:
an initial assessment of lean components and business constraints of a business; and
a complete assessment of drivers of value which are correlated to technical specifications and provided in response to the initial assessment; and
a report tool to generate a report of at least the complete assessment.

14. The system of claim 13, further comprising an assessment database containing questions, answers and associated scores for the lean components and the business constraints.

15. The system of claim 13, further comprising a complete client operational assessment database which stores drivers of value, the technical specifications, and correlation information, wherein the assessment tool maps the drivers of value and the technical specifications to scores and correlates the correlation information to a business solution.

16. The system of claim 13, wherein the assessment tool calculates a weighted score based on quality and productivity gains which are obtained by making improvements to the lean components.

17. A computer program product comprising a computer usable storage medium having readable program code embodied in the storage medium, the computer program product includes at least one component operable to:
correlate assessments to lean components associated with a business;
correlate a business environment to business constraints;
return areas of improvement opportunity based on the correlated assessments and business environment;
correlate assessment results to appropriate value drivers for the business;
provide an automated identification of technical specifications based on results of the value drivers; and
return areas of prioritized technical specifications of opportunity based on the automated identification.

18. The computer program product of claim 17, further comprising scoring the value drivers and, based on the score, identify the technical specifications that address the value drivers to provide business value.

19. The computer program product of claim 17, wherein the correlation of the assessment results to appropriate value drivers for the business is one of “one-to-one”, “one-to-many” and “many-to-one” relationships.

20. The computer program product of claim 17, further comprising developing improvement strategies to address identified needs and constraints of the business.

21. The computer program product of claim 17, wherein the value drivers include:
quality;
risk management issues;
business (industry) and technology expertise;
financial value; and
scalability of information technology.

22. The computer program product of claim 17, further comprising:
calculating an average score for each of the one or more drivers of value, D̅i̅, as follows:
$${\overline{D}}_{i} = \frac{1}{{ξ}_{i}} {\sum }_{k = 1}^{t} {w}_{k}^{( i , 0 )} \cdot {M}_{k}^{( i , 0 )} \cdot {q}_{k} \qquad ( 1 )$$
where ωₖ^{(i,0)} is a weighting factor for the question scores associated with the ith driver of value, Mₖ^{(i,0)} is 1 for questions that impact the driver of value and 0 otherwise, ξi represents a number of non-zero elements associated with each driver of value, i, t is a total number of questions in the assessment, and qₖ represents the score for each question; and
calculating an average score for each of the technical specifications, L̅ⱼ, as follows:
$${\overline{L}}_{j} = \frac{1}{{ζ}_{j}} {\sum }_{k = 1}^{t} {w}_{k}^{( 0 , j )} \cdot {M}_{k}^{( 0 , j )} \cdot {q}_{k 1} \qquad ( 2 )$$
where ζj represents the number of non-zero elements associated with each driver of value, j, and Mₖ^{(0,j)} is 1 for questions that impact the technical specification (i.e., opportunity lever) and 0 otherwise,
wherein an underlying construct for the equations represents a set of questions that is aligned to both the one or more of the value drivers and the technical specifications as represented by:
A={Q|D,L}
where A denotes a set of all questions Q having properties of both the one or more drivers of value D, and technical specifications, L;
wherein if B represents the set of questions aligned to the one or more drivers of value B={Q|D}) and C represents the set of questions aligned to the technical specifications (C={Q|L}), then:
B∩C={q|qεB and qεC}
where B∩C is a set of questions common to both B and C.

23. A computer system for assessing business opportunities, the system comprising:
a CPU, a computer readable memory and a computer readable storage media;
first program instructions to correlate assessments to lean components associated with a business;
second program instructions to correlate a business environment to business and environment constraints;
third program instructions to correlate assessments to appropriate value drivers for the business; and
fourth program instructions to correlate assessments to specifications of a solution and provide automated identification of specifications of a solution that can drive benefit based on results of the value drivers; and
wherein the first, second, third, and fourth program instructions are stored on the computer readable storage media for execution by the CPU via the computer readable memory.

24. The computer system of claim 23, further comprising program instructions to return prioritized technical specifications of opportunity based on the automated identification

25. A method of deploying a system for assessing business opportunities comprising:
providing a computer infrastructure, being operable to:
provide an initial assessment of business operations using business constraints and lean capabilities including lean components;
determine a need for improvement based on scores provided in the initial assessment; and
provide a complete assessment using business drivers and specifications of a solution based on the need for improvement.
